(19) United States
(12) Patent Application Publication
(10) Pub. No.: US 2013/0157623 A1
(43) Pub. Date: Jun. 20, 2013

(54) METHOD AND SYSTEM FOR DELIVERING MESSAGES TO ONE OR MORE HANDHELD COMMUNICATION DEVICES

(71) Applicant: BROADCOM CORPORATION, IRVINE, CA (US)

(72) Inventor: Tony Kirke, San Francisco, CA (US)

(73) Assignee: BROADCOM CORPORATION, IRVINE, CA (US)

(21) Appl. No.: 13/769,745

(22) Filed: Feb. 18, 2013

Related U.S. Application Data
(63) Continuation of application No. 11/422,649, filed on Jun. 7, 2006, now abandoned.

(51) Int. Cl. H04W 12/08

(52) U.S. Cl. CPC H04W 12/08
USPC 455/411

(57) ABSTRACT

Methods and systems for communicating information within a network are disclosed. The method may include accessing by a first wireless handheld communication device (WHCD), a list of devices authorized to access a second WHCD. The list of devices may be maintained by a centralized communication device that facilitates communication between the first WHCD and the second WHCD. The first WHCD may not be paired with the second WHCD. A communication link may be established between the first WHCD and the second WHCD via the centralized communication device, if the list of devices authorized to access the second WHCD comprises an identifier (ID) of the first WHCD. Authentication information of the first WHCD may be communicated to the centralized communication device, prior to the accessing by the first WHCD of the list of devices. The accessing by the first WHCD may be authorized based on the communicated authentication information.

### CROSS-REFERENCE TO RELATED APPLICATIONS/INCORPORATION BY REFERENCE

The present U.S. Utility Patent Application claims priority pursuant to 35 U.S.C. §120, as a continuation, to the following U.S. Utility Patent Application which is hereby incorporated herein by reference in its entirety and made part of the present U.S. Utility Patent Application for all purposes:

1. U.S. Utility application Ser. No. 11/422,649 entitled “Method and System for Delivering Messages to One or More Handheld Communication Devices,” (Attorney Docket No. BP5214) filed Jun. 7, 2006, pending.

This application also makes reference to:

U.S. patent application Ser. No. 11/422,637 filed on Jun. 7, 2006;

U.S. patent application Ser. No. 11/422,638 filed on Jun. 7, 2006;

U.S. patent application Ser. No. 11/422,640 filed on Jun. 7, 2006;

U.S. patent application Ser. No. 11/422,645 filed on Jun. 7, 2006;

U.S. patent application Ser. No. 11/422,657 filed on Jun. 7, 2006; and

U.S. patent application Ser. No. 11/422,664 filed on Jun. 7, 2006.

Each of the above stated applications is hereby incorporated herein by reference in its entirety.

### FIELD OF THE INVENTION

Certain embodiments of the invention relate to communication of information within a network. More specifically, certain embodiments of the invention relate to a method and system for delivering messages to one or more wireless handheld communication devices.

### BACKGROUND OF THE INVENTION

Wireless technology is revolutionizing personal connectivity by providing freedom from wired connections. Conventional wireless connectivity protocols for wireless handheld communication devices, such as Bluetooth®, may provide a small form-factor, low-cost radio solution which may support links between computers, mobile phones and/or other portable and wireless handheld communication devices. Bluetooth® wireless technology is an international, open standard for allowing intelligent devices to communicate with each other through wireless, short-range communications. The Bluetooth® technology allows a Bluetooth® compliant device, such as a Bluetooth®-enabled computer, computer mouse, computer keyboard, speakers, or a wireless handheld communication device, for example, to support its own connections, without wires, cables or any direct action from a user. Bluetooth® is currently incorporated into numerous commercial products including laptops, PDAs, cell phones, keyboards, and printers, for example.

Bluetooth® handheld communication devices, such as mobile telephones and PDAs, are evolving to become more complex as such devices may be adapted to transmit and receive audio and/or video information. However, communicating data, such as audio and video data between Bluetooth®-enabled devices via a Bluetooth® connection requires increased power consumption and may be achieved at data rates that are slower than data rates offered by high-speed connections. Furthermore, conventional wireless connectivity standards for wireless handheld communication devices, such as the Bluetooth® standard, are effective within a limited distance range. In addition, the Bluetooth® standard requires that Bluetooth®-enabled devices be paired prior to communication of information via a Bluetooth® link. Also, paired Bluetooth®-enabled devices may communicate only at a limited distance, in most instances up to 10 meters. Furthermore, only a limited number of Bluetooth®-enabled devices may establish a communication link between each other and communicate information via the established Bluetooth® link.

Further limitations and disadvantages of conventional and traditional approaches will become apparent to one of skill in the art, through comparison of such systems with some aspects of the present invention as set forth in the remainder of the present application with reference to the drawings.

### BRIEF DESCRIPTION OF SEVERAL VIEWS OF THE DRAWINGS

FIG. 1 is a diagram illustrating communication between a plurality of wireless handheld communication devices in an ad-hoc network, in accordance with an embodiment of the invention.

FIG. 2 is a diagram illustrating a plurality of ad-hoc networks comprising wireless handheld communication devices, in accordance with an embodiment of the invention.

FIG. 3 is a diagram illustrating communication of information between wireless handheld communication devices, in accordance with an embodiment of the invention.

FIG. 4 is a diagram illustrating communication of information between wireless handheld communication devices, in accordance with an embodiment of the invention.

FIG. 5 is a block diagram of an exemplary wireless handheld communication device transmitter, which may be utilized in accordance with an embodiment of the invention.

FIG. 6A is a block diagram of an exemplary wireless handheld communication device receiver, which may be utilized in accordance with an embodiment of the invention.

FIG. 6B is a diagram illustrating exemplary use of a wireless handheld communication device as a secure key, in accordance with an embodiment of the invention.

FIG. 6C is a diagram illustrating discovery and establishment of a communication link between or among a plurality of communication devices, in accordance with an embodiment of the invention.

FIG. 7 is a diagram of a wireless handheld communication device in an ad-hoc network utilizing a list of authorized devices, in accordance with an embodiment of the invention.

FIG. 8 is a flowchart illustrating exemplary steps for communicating information within a network, in accordance with an embodiment of the invention.

FIG. 9A is a flowchart illustrating exemplary steps for communicating information within a network, in accordance with an embodiment of the invention.

FIG. 9B is a flowchart illustrating exemplary steps for communicating information within a network, in accordance with an embodiment of the invention.

### DETAILED DESCRIPTION OF THE INVENTION

A system and/or method is provided for delivering messages to one or more wireless handheld communication devices, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

Certain embodiments of the invention provide delivery of messages to one or more wireless handheld communication devices. Various aspects of the invention may comprise accessing by a first wireless handheld communication device (WHCD), a list of devices authorized to access a second WHCD. The list of devices may be maintained by a centralized communication device that facilitates communication between the first WHCD and the second WHCD. In various embodiments of the invention, the first WHCD is not paired with the second WHCD. A communication link may be established between the first WHCD and the second WHCD via the centralized communication device, if the list of devices authorized to access the second WHCD comprises an identifier (ID) of the first WHCD. Authentication information for the first WHCD may be communicated to the centralized communication device prior to the accessing by the first WHCD of the list of devices. The accessing by the first WHCD may be authorized based on the communicated authentication information.

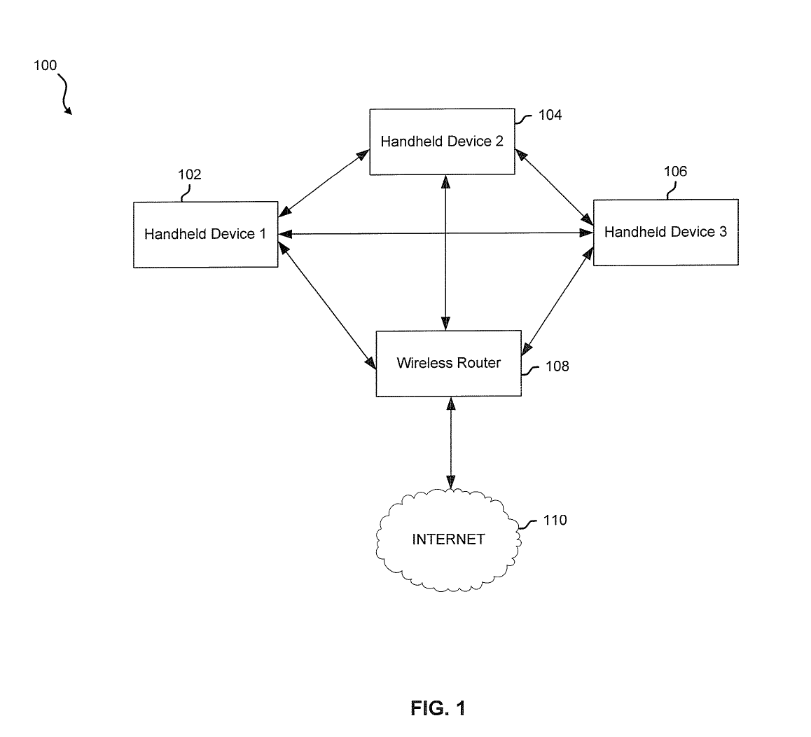

FIG. 1 is a diagram illustrating communications between a plurality of wireless handheld communication devices in an ad-hoc network, in accordance with an embodiment of the invention. Referring to FIG. 1, the ad-hoc network 100 may comprise a plurality of wireless handheld communication devices, such as wireless handheld communication devices 102, 104, and 106. The wireless handheld communication devices 102, 104, and 106 may each comprise suitable circuitry, logic, and/or code and may communicate information wirelessly within the ad-hoc network 100. For example, wireless handheld communication devices 102, 104, and 106 may communicate voice or data between each other over extended ranges, without the use of a network device, such as an access point, a base station, a bridge, a router, and/or a switch, for example, to facilitate such communication. The extended range may be much greater than the range provided by Bluetooth.

In one embodiment of the invention, wireless handheld communication devices 102, 104, and 106 may utilize instant messaging (1M) to communicate data within the ad-hoc network 100. For example, during an initial formation of the ad-hoc network 100, the wireless handheld communication device 102 may detect the presence of the wireless handheld communication device 104. Wireless handheld communication devices 102 and 104 may then exchange identification information related to the devices 102 and 104 and/or to the corresponding users of the devices 102 and 104. For example, wireless handheld communication devices 102 and 104 may exchange user identification information. After wireless handheld communication devices 102 and 104 exchange user identification information and authenticate each other, a connection may be established for a wireless exchange of data between the wireless handheld communication devices 102 and 104. In one embodiment of the invention, the connection may be utilized to initiate a messaging session such as, for example, an instant messaging session between devices.

After an 1M wireless connection is established between wireless handheld communication devices 102 and 104, a third wireless handheld communication device 106, located within operating range of wireless handheld communication devices 102 and 104, may be detected by device 102 and/or device 104. After wireless handheld communication device 106 is detected by wireless handheld communication device 102 and/or wireless handheld communication device 104, identification information may be exchanged between wireless handheld communication device 106 and wireless handheld communication devices 102 and 104. Wireless handheld communication device 106 may then be accepted within the ad-hoc network 100 and 1M communication may be established between wireless handheld communication devices 102, 104, and 106.

In another embodiment of the invention, wireless handheld communication devices 102, 104, and 106 may each communicate with the wireless router 108. The wireless router 108 may be communicatively coupled to the Internet 110. In this regard, one or more of the wireless handheld communication devices 102, 104, and 106 may operate both within the ad-hoc network 100 and within an infrastructure network comprising, for example, the router 108 and one or more devices communicatively coupled to the Internet 110.

In yet another embodiment of the invention, one or more of the wireless handheld communication devices 102, 104, 106 may generate a list of authorized devices that are allowed to communicate with the respective wireless handheld communication device without pairing the wireless handheld communication device with any device that is specified in the list of authorized devices.

The list of authorized devices may comprise device identification (10) information for each of the authorized devices in the list. For example, wireless handheld communication device 102 may generate a list of authorized devices that are allowed to communicate with the wireless handheld communication device 102. The list of authorized devices may comprise, for example, wireless handheld communication devices 104, 106, and the wireless router 108. Furthermore, the list of authorized devices may be generated by the wireless handheld communication device 102 without pairing the wireless handheld communication device 102 with any of the other communication devices 104, 106 and/or with the wireless router 108. The wireless handheld communication device 102 may establish a communication link with one or more of the wireless handheld communication devices listed on its authorized devices list, with or without the use of an intermediate communication device, such as a network device. The intermediate communication device may comprise a router, a switch, and/or an access point, for example.

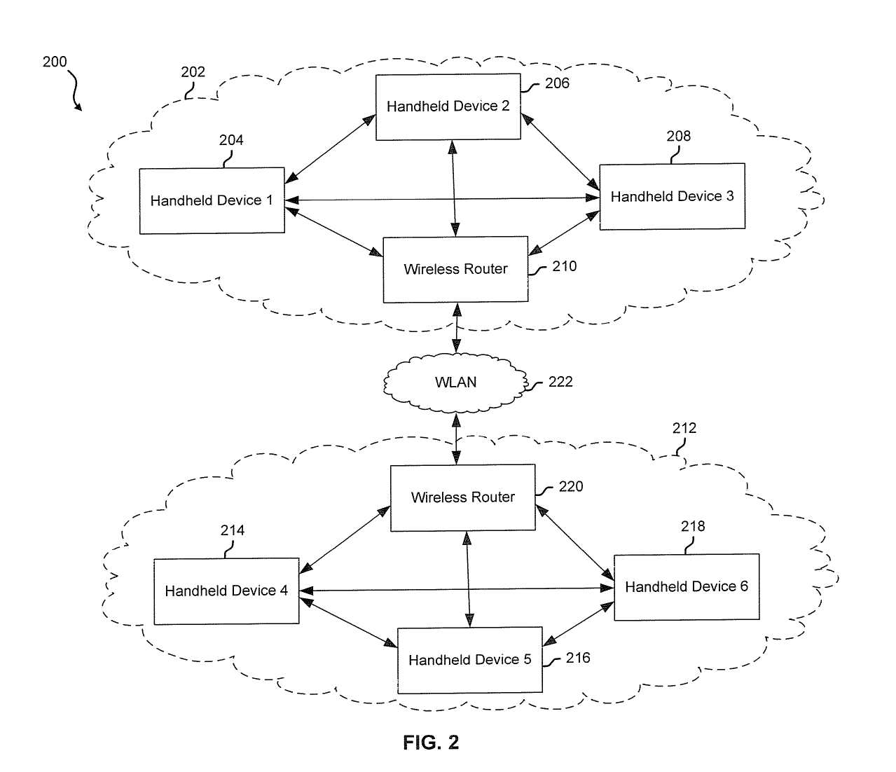

FIG. 2 is a diagram illustrating a plurality of ad-hoc networks comprising wireless handheld communication devices, in accordance with an embodiment of the invention. Referring to FIG. 2, the communication infrastructure 200 may comprise ad hoc networks 202 and 212. The ad-hoc network 202 may comprise a plurality of wireless handheld communication devices, such as wireless handheld communication devices 204, 206, and 208. The wireless handheld communication devices 204, 206, and 208 may each comprise suitable circuitry, logic, and/or code and may communicate information wirelessly over an extended range within the ad-hoc network 202. For example, wireless handheld communication devices 204, 206, and 208 may communicate voice or data between each other over extended ranges, without the use of a network device, such as an access point, a base station, a bridge, a router, and/or a switch, for example, to facilitate such communication. The extended range may be much greater than the range provided by Bluetooth.

Similarly, the ad-hoc network 212 may comprise a plurality of wireless handheld communication devices, such as wireless handheld communication devices 214,216, and 218. The wireless handheld communication devices 214, 216, and 218 may each comprise suitable circuitry, logic, and/or code and may communicate information wirelessly within the ad-hoc network 212. For example, wireless handheld communication devices 214, 216, and 218 may communicate voice or data between each other over extended ranges, without the use of a network device, such as an access point, a base station, a bridge, a router, and/or a switch, for example, to facilitate such communication. The extended ranges may be much greater than the range provided by Bluetooth.

In one exemplary embodiment of the invention, wireless handheld communication devices 204, 206, and 208 may utilize instant messaging (1M) to wirelessly communicate data over an extended range within the ad-hoc network 202 when the devices are within operating range of each other. Similarly, wireless handheld communication devices 214,216, and 218 may utilize, for example, instant messaging (1M) to communicate data within the ad-hoc network 212. One or more of the wireless handheld communication devices 204, 206, and 208, within ad-hoc network 202, and wireless handheld communication devices 214, 216, and 218, within ad-hoc network 212, may communicate with the wireless routers 210 and 220, respectively. The wireless routers 210 and 220 may be communicatively coupled to a wireless local area network (WLAN) 222. In this regard, one or more of the wireless handheld communication devices 204, . . . , 208 may simultaneously communicate information to one or more wireless handheld communication devices within the ad-hoc network 202, and to one or more wireless handheld communication device within the ad-hoc network 212, via the wireless routers 210,220 and the WLAN 222. Similarly, one or more of the wireless handheld communication devices 214, . . . , 218 may communicate information within the ad-hoc network 212 and with one or more wireless handheld communication device within the ad-hoc network 202, via the wireless routers 210,220 and the WLAN 222.

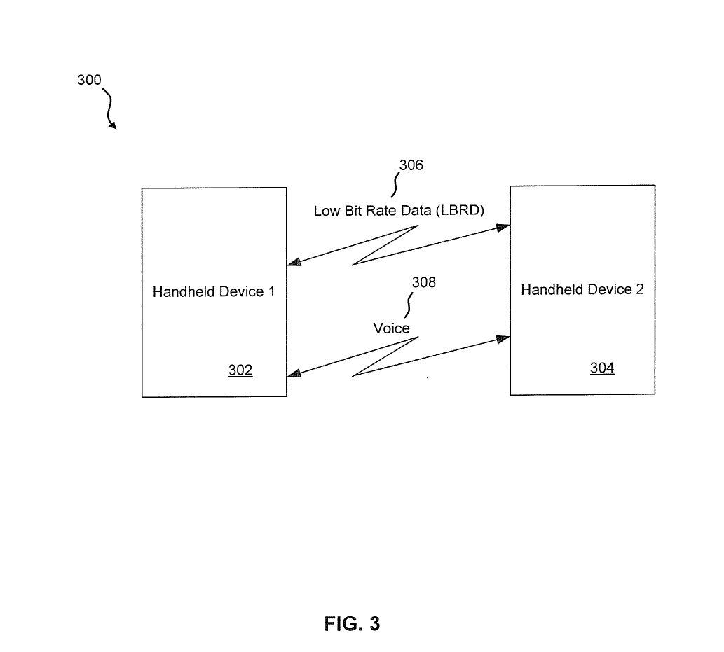

FIG. 3 is a diagram illustrating communication of information between wireless handheld communication devices, in accordance with an embodiment of the invention. Referring to FIG. 3, wireless handheld communication devices 302 and 304 may form an ad-hoc network 300. In this regard, wireless handheld communication devices 302 and 304 may exchange information without using an intermediate communication device, such as an access point, a base station, a bridge, a router, and/or a switch that facilitates communication between the wireless handheld communication devices 302 and 304. The wireless handheld communication devices 302 and 304 may comprise, for example, a cell phone or a personal digital assistant (PDA). Furthermore, the wireless handheld communication devices 302 and 304 may communicate low bit-rate data (LBRD) 306 and/or voice data 308. The LBRD 306 may be exchanged during, for example, an instant messaging (1M) connection established between the wireless handheld communication devices 302 and 304.

In operation, the wireless handheld communication device 302 may detect the presence of the wireless handheld communication device 304 when the latter is within operating range of the former. Wireless handheld communication devices 302 and 304 may then exchange identification information related to the devices 302 and 304 and/or identification information related to the corresponding users of the devices 302 and 304. After wireless handheld communication devices 302 and 304 exchange user identification information and authenticate each other, a connection may be established between wireless handheld communication devices 302 and 304 for a wireless exchange of LBRD 306 and/or exchange of voice information 308.

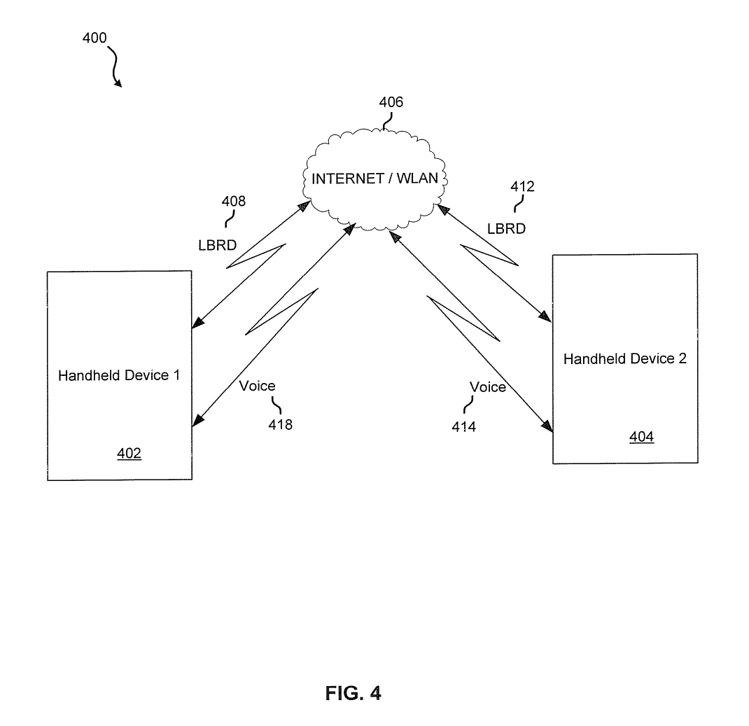

FIG. 4 is a diagram illustrating communication of information between wireless handheld communication devices, in accordance with an embodiment of the invention. Referring to FIG. 4, wireless handheld communication devices 402 and 404 may form a communication infrastructure 400. The communication infrastructure 400 may also comprise the Internet or a WLAN 406. The wireless handheld communication devices 402 and 404 may exchange information via the Internet or WLAN 406. The wireless handheld communication devices 402 and 404 may comprise, for example, a cell phone or a personal digital assistant (PDA). Furthermore, the wireless handheld communication devices 402 and 404 may communicate low bit-rate data (LBRD) 408 and 412 and/or voice data 418 and 414.

For example, LBRD 408 may be communicated between the Internet/WLAN 406 and the wireless handheld communication device 402, and LBRD 412 may be communicated between the Internet/WLAN 406 and the wireless handheld communication device 404. Similarly, voice data 418 may be communicated between the Internet/WLAN 406 and the wireless handheld communication device 402, and voice data 414 may be communicated between the Internet/WLAN 406 and the wireless handheld communication device 404. The LBRD 408 and 412 may be exchanged during, for example, an instant messaging (1M) connection established between the wireless handheld communication devices 402 and 404 via the Internet/WLAN 406.

In operation, the wireless handheld communication device 402 may detect the presence of the wireless handheld communication device 404 via the Internet/WLAN 406. Wireless handheld communication devices 402 and 404 may then exchange identification information related to the devices 402 and 404 and/or identification information related to the corresponding users of the wireless handheld communication devices 402 and 404. After wireless handheld communication devices 402 and 404 exchange user identification information and authenticate each other, a connection may be established between wireless handheld communication devices 406 and 408 via the Internet/WLAN 406 for a wireless exchange of LBRD 408 and 412 and/or exchange of voice information 418 and 414.

In one embodiment of the invention, wireless handheld communication device 402 may store identification information of wireless handheld communication device 404, prior to pairing the devices 402 and 404 or prior to establishing any connection or communication between the devices 402 and 404 when the latter is within operating range of the former. In this regard, wireless handheld communication device 404 may be “pre-authorized” to communicate with wireless handheld communication device 402. In instances when wireless handheld communication device 404 is preauthorized for communication with wireless handheld communication device 402, an ad hoc network connection may be established between devices 402 and 404 at the time wireless handheld communication device 402 detects wireless handheld communication device 404.

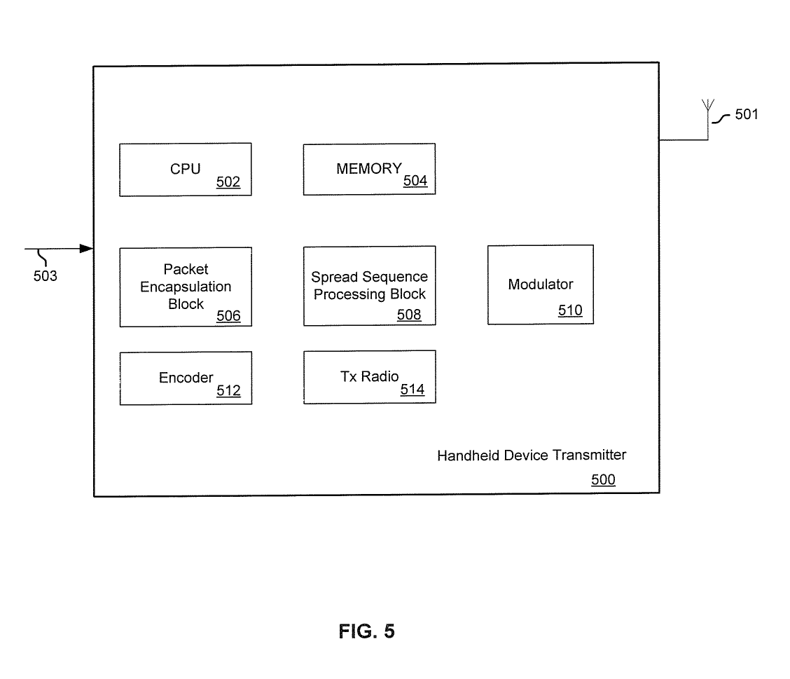

FIG. 5 is a block diagram of an exemplary wireless handheld device transmitter, which may be utilized in accordance with an embodiment of the invention. Referring to FIG. 5, the exemplary wireless handheld device transmitter 500 may comprise a CPU 502, memory 504, a packet encapsulation block 506, a spread sequence processing block 508, a modulator 510, an encoder 512, an antenna 501, and a transmit (Tx) radio 514.

The packet encapsulation block 506 may comprise suitable circuitry, logic, and/or code and may enable packetizing of the received data 503. For example, the packet encapsulation block 506 may insert protocol headers and/or device identification information within the received data 503. In one embodiment of the invention, the received data 503 may be initially encoded by the encoder 512, prior to packetization by the packet encapsulation block 506.

The spread sequence processing block 508 may comprise suitable circuitry, logic, and/or code and may utilize one or more spread sequences to process packetized data received from the packet encapsulation block 506. The modulator 510 may comprise suitable circuitry, logic, and/or code and may enable modulation of data processed by the spread sequence processing block 508. The Tx radio block 514 may comprise suitable circuitry, logic, and/or code and may enable transmission of modulated data via the antenna 501.

In operation, received data 503, such as voice data, may be initially encoded by the encoder 512. Encoded data may be packetized by the packet encapsulation block 506, thereby inserting protocol headers and/or device identification information. Packetized data may be processed by the spread sequence processing block 508 utilizing one or more spread sequences. Processed data may be communicated from the spread sequence processing block 508 to the modulator 510 for modulation. Modulated data may be transmitted by the Tx radio block 514 via the antenna 501.

In one embodiment of the invention, the device identification information inserted by the packet encapsulation block 506 may comprise information identifying a wireless handheld device and/or a user of the wireless handheld device. In this regard, the inserted device identification information may be used by one or more devices receiving the device identification information to establish a wireless connection and/or to perform a specific task based on authentication of the device identification information. For example, a first wireless handheld device may communicate data comprising device identification information to a second wireless handheld communication device. The second wireless handheld communication device may then authorize the first wireless handheld communication device based on the received device identification information.

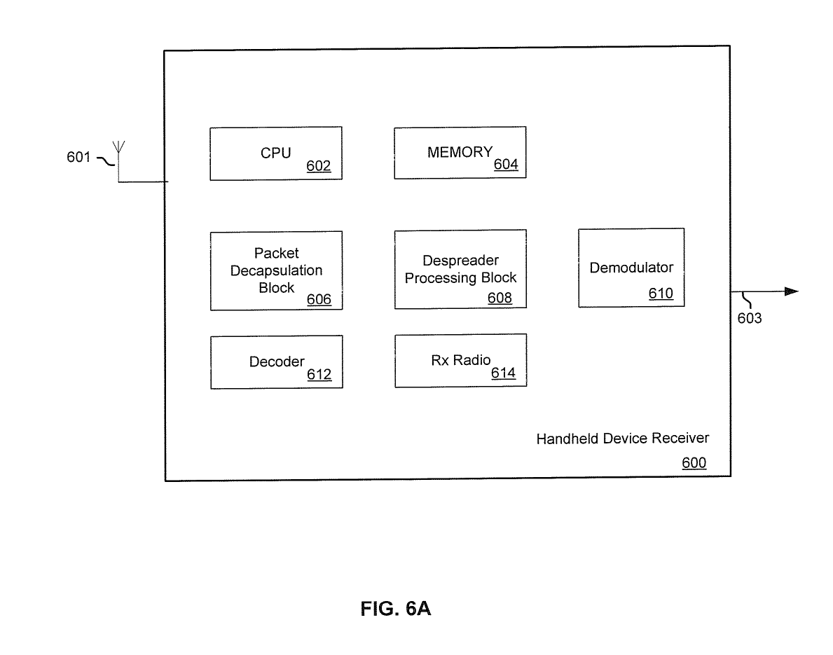

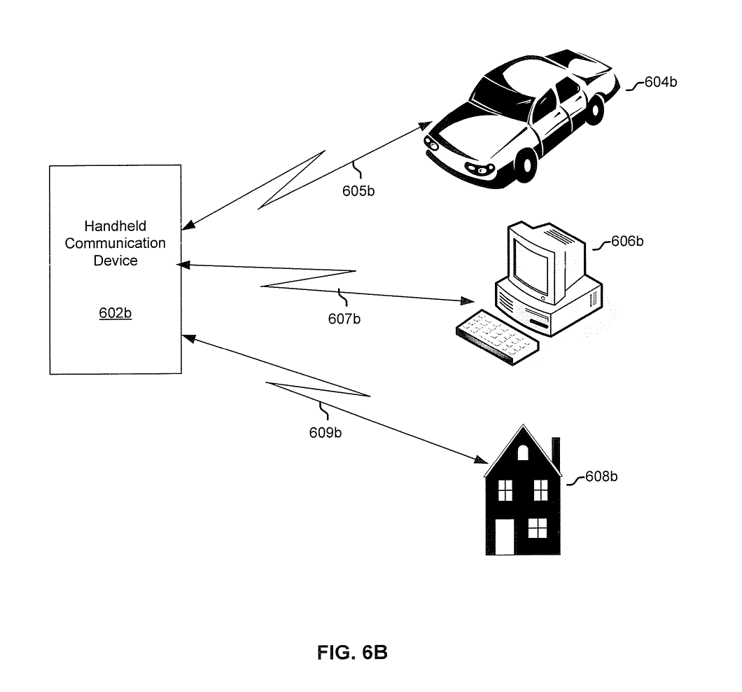

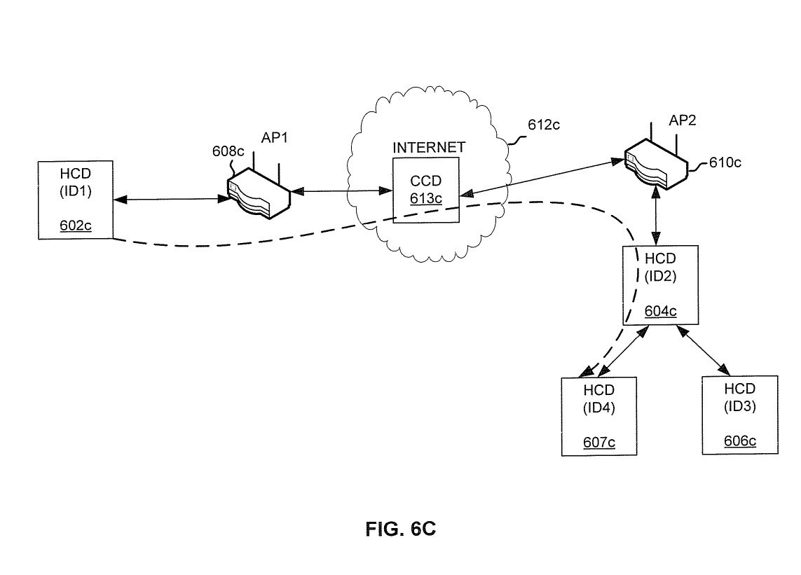

FIG. 6A is a block diagram of an exemplary wireless handheld communication device receiver, which may be utilized in accordance with an embodiment of the invention. Referring to FIG. 6A, the wireless handheld communication device receiver may comprise a CPU 602, memory 504, a packet decapsulation block 606, a despreader processing block 608, a demodulator 610, a decoder 612, an antenna 601, and a receive (Rx) radio 614.

The demodulator 610 may comprise suitable circuitry, logic, and/or code and may enable demodulation of data received from the Rx radio block 614 via the antenna 601. The despreader processing block 608 may comprise suitable circuitry, logic, and/or code and may despread demodulated data received from the demodulator 610. The packet decapsulation block 606 may comprise suitable circuitry, logic, and/or code and may enable decapsulation despread data received from the despreader processing block 608. After decapsulation, protocol headers and/or device identification information may be obtained and the remaining data 603 may be communicated outside the wireless handheld communication device receiver 600 for further processing.

FIG. 6B is a diagram illustrating exemplary use of a wireless handheld communication device as a secure key, in accordance with an embodiment of the invention. Referring to FIG. 6B, the wireless handheld communication device 602b may comprise a wireless handheld communication device receiver, such as the wireless handheld communication device receiver 600 in FIG. 6A. In addition, the wireless handheld communication device 602b may comprise a wireless handheld communication device transmitter, such as the wireless handheld communication device transmitter 500 in FIG. 5.

In one embodiment of the invention, the vehicle 604b may comprise circuitry which may generate a list of authorized devices that are allowed to communicate with the vehicle 604b without pairing the vehicle 604b with any other device from the list of authorized devices. For example, the list of authorized devices maintained by the vehicle 604b may comprise devices that may be authorized to remotely unlock the vehicle 604b and/or to remotely start the vehicle 604b. In operation, the wireless handheld communication device 602b may communicate device identification information 605b within transmitted data. If the list of authorized devices maintained by the vehicle 604b comprises wireless handheld communication device 602b, the vehicle 604b may perform one or more functions, such as remote unlock and/or remote start, after the vehicle 604b receives the device identification information 605b.

In another embodiment of the invention, the personal computer (PC) 606b may comprise circuitry which may generate a list of authorized devices that are allowed to communicate with the PC 606b without pairing the PC 606b with any other device from the list of authorized devices. For example, the list of authorized devices maintained by the PC 606b may comprise devices that may be authorized to display information on a display connected to the PC 606b, and/or to utilize a different functionality of the PC 606b. In operation, the wireless handheld communication device 602b may communicate device identification information 607b within transmitted data. If the list of authorized devices maintained by the PC 606b comprises wireless handheld communication device 602b, the PC 606b may perform the desired functions, such as displaying information on a display connected to the PC 606b.

In yet another embodiment of the invention, the personal residence (PR) 608b may utilize circuitry which may generate a list of authorized devices that are allowed to communicate with the PR 608b without pairing the PR 608b with any other device from the list of authorized devices. For example, the list of authorized devices maintained by the PR 608b may comprise devices, or device users, that may be authorized to gain entry access, for example, to the PR 608b. In operation, the wireless handheld communication device 602b may communicate device identification information 60gb within transmitted data. If the list of authorized devices maintained by the PR 608b comprises wireless handheld communication device 602b, the PR 608b may perform the desired functions, such as authorize entry access to the holder of the wireless handheld communication device 602b. Such entry access may be granted after the PR 608b receives the device identification information 60gb and authenticates the wireless handheld communication device 602b.

FIG. 6C is a diagram illustrating discovery and establishment of a communication link between or among a plurality of communication devices, in accordance with an embodiment of the invention. Referring to FIG. 6C, there is illustrated communication of information between wireless handheld communication devices 602c, . . . , 607c, a centralized communication device (CCD) 613c, and a plurality of intermediate devices, such as access points 608c and 610c. Each of the wireless handheld communication devices 602c, . . . , 607c may comprise device identification (10) information. For example, the wireless handheld communication devices 602c, . . . , 607c may comprise device IDs ID1, . . . , ID4, respectively. The CCD 613c may be connected to the APs 608c and 610c via a wired and/or wireless connection. Furthermore, the APs 608c and 610c may access the CCD 613c via the Internet 612c and/or via a local area network (LAN) or a wireless local area network (WLAN).

In one embodiment of the invention, a plurality of wireless handheld communication devices that are out of each other's operating range, may discover each other and establish a communication link utilizing the CCD 613c and one or more of the access points 608c and 610c. For example, the wireless handheld communication device 604c may be wirelessly connected to access point 610c within a first WLAN. Similarly, the wireless handheld communication device 602c may be wirelessly connected to access point 608c within a second WLAN. The access points 608c and 610c may be communicatively coupled to the CCD 613c via communication links established using the Internet 612c.

In another embodiment of the invention, the CCD 613c may be used to facilitate communication of information between two or more of the wireless handheld communication devices 602c, . . . , 607c and/or the APs 608c and 610c. The CCD 613c may be adapted to maintain a list of known or authorized devices (KAO list) that is unique for one or more of the wireless handheld communication devices 602c, . . . , 607c and/or the APs 608c and 610c. In this regard, the CCD 613c may maintain a database of KAO lists for a plurality of devices and may authorize one or more of the wireless handheld communication devices 602c, . . . , 607c and/or the APs 608c and 610c to access the KAO lists. Access to the KAO lists maintained by the CCD 613c may be authorized based on a password, and/or device identification information, for example.

In another embodiment of the invention, if a first wireless handheld communication device that is not within any of the KAO lists maintained by the CCD 613c establishes a connection with a second wireless handheld communication device that is within one or more of the KAO lists, the KAO list associated with the second wireless handheld communication device may be updated so that it includes identification information associated with the first wireless handheld communication device.

In another embodiment of the invention, a website supported by the CCD 613c may provide a lookup service. Consequently, the identity of friends or other users associated with a first wireless handheld communication device that is currently listed in a KAO list or the identity of the wireless handheld communication devices connected with the first wireless handheld communication device may be located and downloaded to a second wireless handheld communication device. Once the identity of another user's wireless handheld communication device is downloaded and stored on the second wireless handheld communication device, communication may be initiated based on the stored identity.

For example, the wireless handheld communication device 602c may access, via the AP 608c, a KAO list of the wireless handheld communication device 604c that is maintained by the CCD 613c. The KAO list of wireless handheld communication device 604c may list identities 103 and 104 of the wireless handheld communication devices 606c and 607c that are connected to the wireless handheld communication device 604c. After the wireless handheld communication device 602c is authenticated by the CCD 613c, the wireless handheld communication device 602c may access the KAO list of the wireless handheld communication device 604c. The wireless handheld communication device 602c may then establish a communication link with the wireless handheld communication device 607c, via the APs 608c, 610c, the CCD 613c, the Internet 612c and the wireless handheld communication device 604c. In yet another embodiment of the invention, the CCD 613c may enable conferencing among a plurality of wireless handheld communication devices, such as two or more of the wireless handheld communication devices 602c, . . . , 607c. The conferencing services may be provided to devices regardless of whether they are located within operating range of each other or whether they are out of operating range of each other and communicatively coupled to an infrastructure network. For example, a plurality of wireless handheld communication devices that are in the vicinity of a CCD may gain access to each other's KAO lists from the CCD, and a communication link may be established between the wireless handheld communication devices, via the CCD, without any of the wireless handheld communication devices being paired to each other or to the CCD prior to establishing the connection.

Even though the KAO lists comprise device identification information, the present invention may not be so limited. In one embodiment of the invention, the KAO lists may comprise identification information for visible or detected users. For example, the KAO lists may comprise devices that may be in the vicinity of a corresponding wireless handheld communication device, i.e., devices that are “visible” to the wireless handheld communication device. In such instances, another wireless handheld communication device may gain access to the first wireless handheld communication device's KAO list and may establish a communication link with a “visible” device from the KAO list, via a CCD.

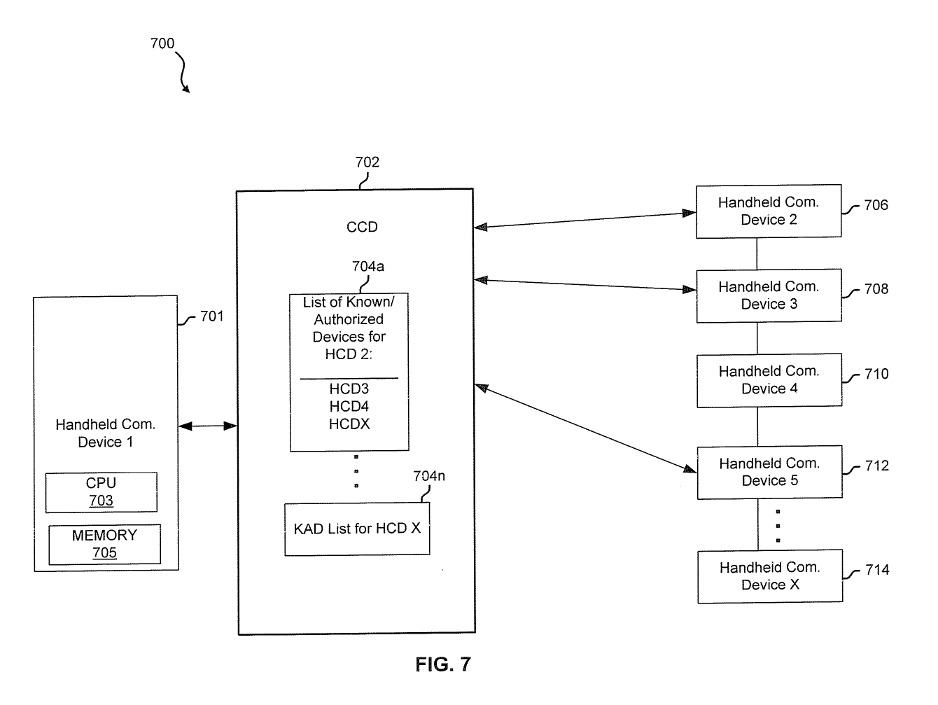

FIG. 7 is a diagram of a wireless handheld communication device in an ad-hoc network utilizing a list of authorized devices, in accordance with an embodiment of the invention. Referring to FIG. 7, the ad-hoc network 700 may comprise a centralized communication device 702 and wireless handheld communication devices 701, 706, . . . , 714. The wireless handheld communication devices 701, 706, . . . , 714 may each comprise suitable circuitry, logic, and/or code and may communicate information wirelessly within the ad-hoc network 700. For example, the wireless handheld communication devices 706, . . . , 714 may communicate voice or data between each other over extended ranges, without the use of a network device, such as an access point, a base station, a bridge, a router, and/or a switch to facilitate such communication. The extended range may be much greater than the range provided by Bluetooth.

The CCD 702 may comprise suitable circuitry, logic, and/or code and may maintain one or more lists of known or authorized devices (KAO lists) 704a, . . . , 704n. Each of the KAO lists 704a, . . . , 704n may correspond to one or more wireless handheld communication devices 706, . . . , 714. For example, the KAO list 704a may comprise a list of wireless handheld communication devices that are known or authorized to communicate with the wireless handheld communication device 706.

The wireless handheld communication device 701 may further comprise a CPU 703 and memory 705. The CPU 703 may enable communication of data to and from the CCD 702. For example, the CPU 703 may also enable communication of device identification information from the wireless handheld communication device 701 to the CCD 702 for purposes of creating one or more KAO lists or acquiring KAO list data maintained by the CCD 702. The KAO lists 704a, . . . , 704n may be stored in the memory 708. The CPU 703 may execute suitable code that may be utilized to manage the KAO lists 704a, . . . , 704n. The CPU 703 may also be used to match information in the KAO list with a device 10 in order to determine whether devices are allowed to communicate with each other.

In one embodiment of the invention, wireless handheld communication device 701 may access the list of authorized devices 704a, maintained by the CCD 702. The wireless handheld communication devices 701 and 706 may be within operating range of the CCD 702 and neither of the wireless handheld communication devices 706 or 701 may be paired with the CCD 702. Furthermore, wireless handheld communication device 706 may be outside an operating range of the wireless handheld communication device 701. After wireless handheld communication device 701 accesses the KAO list 704a corresponding to wireless handheld communication device 706, the wireless handheld communication device may establish a communication link with the wireless handheld communication device 706 via the CCD 702.

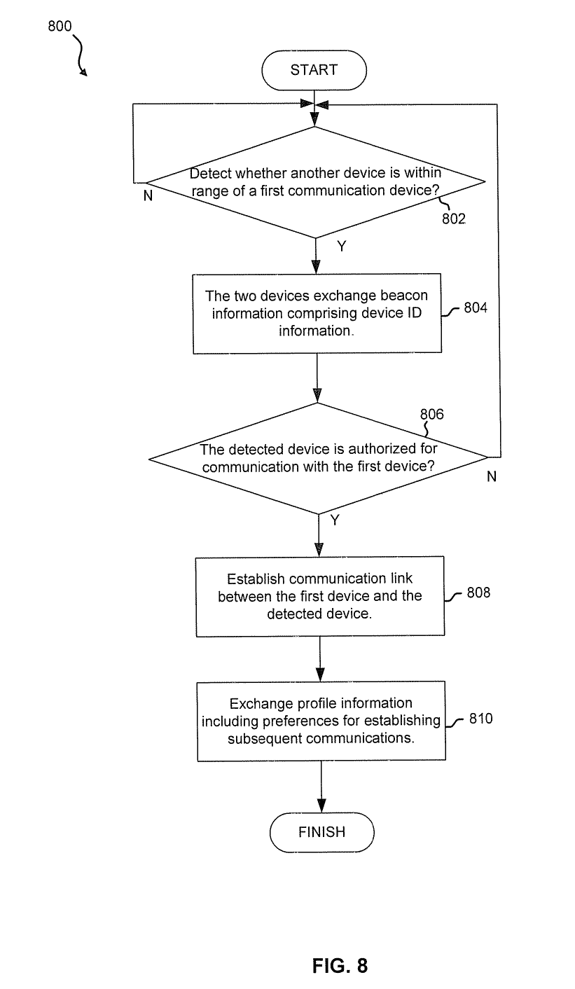

FIG. 8 is a flowchart 800 illustrating exemplary steps for communicating information within a network, in accordance with an embodiment of the invention. Referring to FIGS. 7 and 8, at 802, the wireless handheld communication device 702 may detect whether another wireless handheld communication device is within operating range of the wireless handheld communication device 702. If another wireless handheld communication device, for example wireless handheld communication device 706, is within operating range of the wireless handheld communication device 702, at 804, wireless handheld communication devices 702 and 706 may exchange beacon information, such as device identification information. At 806, the wireless handheld communication device 702 may determine whether the wireless handheld communication device 706 is authorized to communicate with the wireless handheld communication device 702. For example, wireless handheld communication device 702 may match the identification information received from the wireless handheld communication device 706 with identification information stored within the list of authorized devices 704.

If the wireless handheld communication device 706 is not authorized for communicating information with the wireless handheld communication device 702, operation may resume at step 802. If the wireless handheld communication device 706 is authorized for communicating information with the wireless handheld communication device 702, at 808, a communication link may be established between the wireless handheld communication devices 702 and 706. The established communication link may be used to communicate LBRO and/or voice data, for example, between wireless handheld communication devices 702 and 706, without the assistance of an intermediate communication device that comprises a bridging function, a routing function, and/or a switching function. At 810, profile information may be exchanged between the wireless handheld communication devices 702 and 706. The profile information may comprise, for example, preferences for establishing and maintaining subsequent communications, such as preferred time of day and preferred type of information to be exchanged.

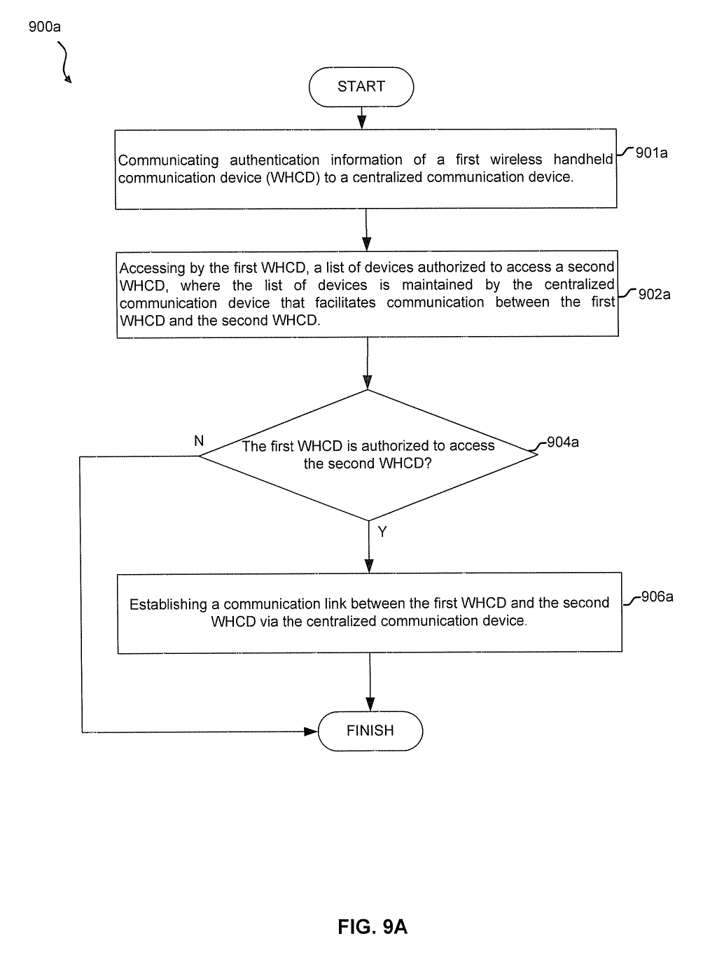

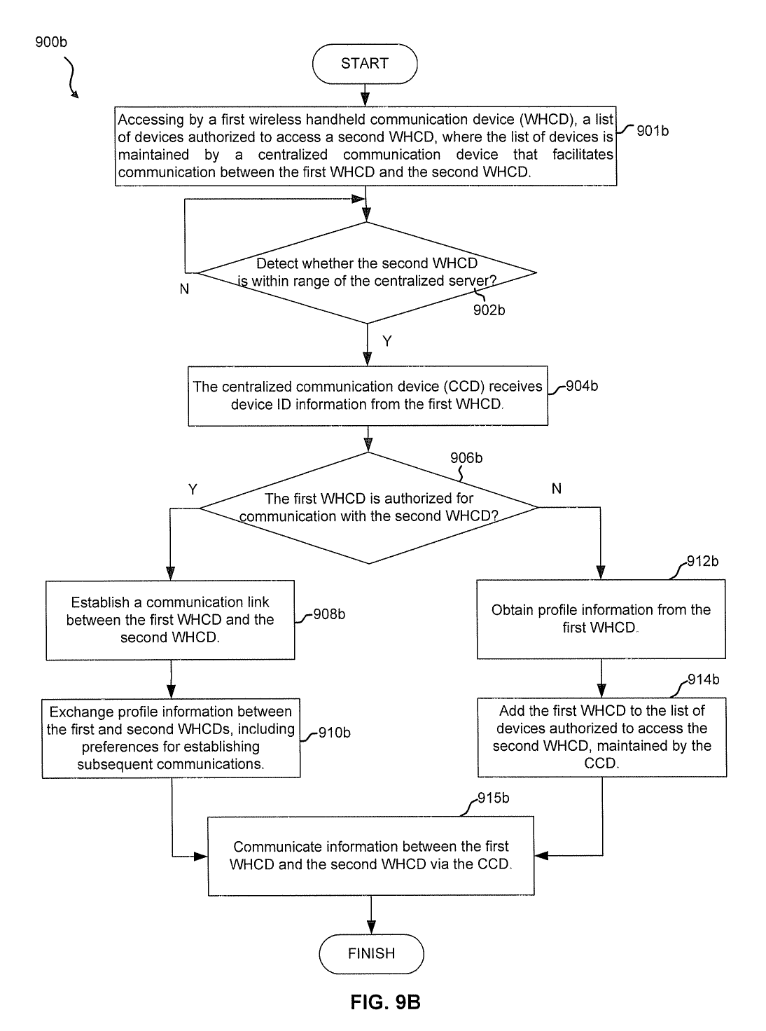

FIG. 9A is a flowchart 900a illustrating exemplary steps for communicating information within a network, in accordance with an embodiment of the invention. Referring to FIGS. 7 and 9A, at 901a, authentication information for the wireless handheld communication device 701 may be communicated to the CCD 702. At 902a, the wireless handheld communication device 701 may access a KAO list 704a that is maintained by the CCD 702. At 904a, it may be determined whether the wireless handheld communication device 701 is authorized to access the wireless handheld communication device 706 based on the KAO list maintained by the WHCD 702. If the wireless handheld communication device 701 is authorized to access the wireless handheld communication device 706, a communication link may be established between the wireless handheld communication devices 701 and 706, via the CCD 702.

FIG. 9B is a flowchart 900b illustrating exemplary steps for communicating information within a network, in accordance with an embodiment of the invention. Referring to FIGS. 7 and 9B, at 901b, the first wireless handheld communication device (WHCD) 701 may access a list of known or authorized devices (KAO list) 704a maintained by a CCD 702 that may be used to facilitate communication between WHCDs. At 902b, the CCD 702 may detect whether the WHCD 706 is within operating range of the CCD 702. At 904b, the CCD 702 may receive device 10 information from the WHCD 701. At 906b, the CCD 702 may determine whether the WHCD 701 is authorized to communicate information with the WHCD 706, based on the device 10 information of the WHCD 701. For example, the CPU 703 and the CCD 702 may match the device 10 information received from the WHCD 701 with identification information stored within the KAO list 704a.

If the WHCD 701 is authorized to communicate with the WHCD 706, at 908b, a communication link may be established between the WHCDs 701 and 706, via the CCD 702. At 910b, after a communication link is established between the WHCDs 701 and 706, profile information may be exchanged between the wireless handheld communication devices 701 and 706. The profile information may comprise, for example, preferences for establishing and maintaining subsequent communications, such as a preferred time of day and/or a preferred type of information to be exchanged, address, date of birth, telephone numbers, and friend lists.

If the WHCD 701 is not authorized to communicate information with the WHCD 706, at 912b, the CCD 702 or the WHCD 706 may request and obtain profile information from the WHCD 701. At 914b, after the CCD 702 or the WHCD 706 receives profile information from the WHCD 701 and the WHCD 701 is approved to communicate with the WHCD 706, the CCD 702 may add the WHCD 701 to the KAD list 704a. At 915b, information may be communicated between the WHCDs 701 and 706, via the CCD 702.

Certain embodiments of the invention may comprise a machine-readable storage having stored thereon, a computer program having at least one code section for communicating information within a network, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

1. A centralized communication device within a network, comprising:
a memory maintaining a plurality of authorized device lists, each of the plurality of authorized device lists being unique to a respective one of a plurality of wireless handheld communication devices and each of the plurality of authorized device lists containing identifiers of one or more devices authorized to access the respective one of the plurality of wireless handheld communication devices; and
circuitry for enabling a first wireless handheld communication device to access an authorized device list of a second wireless handheld communication device to determine whether the first wireless handheld communication device is authorized to access a second wireless handheld communication device;
wherein the circuitry further facilitates the establishment of a communication link between the first wireless handheld communication device and the second wireless handheld communication device when the first wireless handheld communication device is authorized to access the second wireless handheld communication device.

2. The centralized communication device of claim 1, wherein the first wireless handheld communication device is determined to be authorized to access the second wireless handheld communication device when an identifier of the first handheld communication device is within the authorized device list of the second handheld communication device.

3. The centralized communication device of claim 1, wherein the circuitry further authenticates the first wireless handheld communication device prior to enabling the first wireless handheld communication device access to the authorized device list of the second wireless handheld communication device.

4. The centralized communication device of claim 3, wherein the circuitry authenticates the first wireless handheld communication device using at least one of a password and device identification information provided by the first wireless handheld communication device.

5. The centralized communication device of claim 1, wherein the circuitry facilitates the establishment of the communication link between the first wireless handheld communication device and the second wireless handheld communication device via at least one access point in wireless communication with at least one of the first handheld communication device and the second wireless handheld communication device.

6. The centralized communication device of claim 1, wherein the circuitry determines whether the first wireless handheld communication device and the second wireless handheld communication device are within a wireless operating range of the centralized communication device, and if so, establishes the communication link wirelessly between the first wireless handheld communication device and the second wireless handheld communication device.

7. The centralized communication device of claim 1, wherein the circuitry further enables the first wireless handheld communication device access to an authorized device list of a third wireless handheld communication device to determine whether the first wireless handheld communication device is authorized to access the third wireless handheld communication device.

8. The centralized communication device of claim 7, wherein the circuitry further facilitates the establishment of a communication link between the first wireless handheld communication device, the second wireless handheld communication device and the third wireless handheld communication device when the first wireless handheld communication device is authorized to access the second wireless handheld communication device and the third wireless handheld communication device.

9. A first wireless handheld communication device, comprising:
a radio for communicating with a centralized communication device maintaining a plurality of authorized device lists, each of the plurality of authorized device lists being unique to a respective one of a plurality of wireless handheld communication devices and each of the plurality of authorized device lists containing identifiers of one or more devices authorized to access the respective one of the plurality of wireless handheld communication devices; and
a processor for accessing an authorized device list of a second wireless handheld communication device stored within the centralized communication device to determine whether the first wireless handheld communication device is authorized to access the second wireless handheld communication;
wherein the processor further establishes a communication link with the second wireless handheld communication device via the radio when the first wireless handheld communication device is authorized to access the second wireless handheld communication device.

10. The first wireless handheld communication device of claim 9, wherein the processor further provides authentication information to the centralized communication device to enable the centralized communication device to authenticate the first wireless handheld communication device prior to accessing the authorized device list of the second wireless handheld communication device.

11. The first wireless handheld communication device of claim 10, wherein the authentication information includes at least one of a password and device identification information.

12. The first wireless handheld communication device of claim 9, wherein the processor establishes the communication link with the second wireless handheld communication device via at least one access point in wireless communication with at least one of the first handheld communication device and the second wireless handheld communication device.

13. The first wireless handheld communication device of claim 9, wherein the processor establishes the communication link with the second wireless handheld communication device via the centralized communication device.

14. The first wireless handheld communication device of claim 9, wherein the processor further accesses an authorized list of a third wireless handheld communication device to determine whether the first wireless handheld communication device is authorized to access the third wireless handheld communication device.

15. The first wireless handheld communication device of claim 14, wherein the processor establishes the communication link with the second wireless handheld communication device and the third wireless handheld communication device via the centralized communication device when the first wireless handheld communication device is authorized to access the second wireless handheld communication device and the third wireless handheld communication device.

16. A method for communicating information in a network, comprising:
communicating, by a first wireless handheld communication device, with a centralized communication device maintaining a plurality of authorized device lists, each of the plurality of authorized device lists being unique to a respective one of a plurality of wireless handheld communication devices and each of the plurality of authorized device lists containing identifiers of one or more devices authorized to access the respective one of the plurality of wireless handheld communication devices;
accessing, by the first wireless handheld communication device, an authorized device list of a second wireless handheld communication device stored within the centralized communication device to determine whether the first wireless handheld communication device is authorized to access the second wireless handheld communication; and
establishing a communication link with the second wireless handheld communication device when the first wireless handheld communication device is authorized to access the second wireless handheld communication device.

17. The method of claim 16, further comprising:
providing authentication information to the centralized communication device to enable the centralized communication device to authenticate the first wireless handheld communication device prior to accessing the authorized device list of the second wireless handheld communication device.

18. The method of claim 16, wherein the communication link with the second wireless handheld communication device is established via at least one access point in wireless communication with at least one of the first handheld communication device and the second wireless handheld communication device.

19. The method of claim 16, wherein the communication link with the second wireless handheld communication device is established via the centralized communication device.

20. The method of claim 16, further comprising:
accessing, by the first wireless handheld communication device, an authorized list of a third wireless handheld communication device stored within the centralized communication device to determine whether the first wireless handheld communication device is authorized to access the third wireless handheld communication device; and
establishing a communication link with the second wireless handheld communication device and the third wireless handheld communication device via the centralized communication device when the first wireless handheld communication device is authorized to access the second wireless handheld communication device and the third wireless handheld communication device.
